(19) United States
(12) Patent Application Publication
(10) Pub. No.: US 2019/0039837 A1
(43) Pub. Date: Feb. 7, 2019

(54) DEVICE FOR ASSEMBLING GARBAGE CAN

(71) Applicants: Junxiong ZHOU, Guangdong (CN); Junhao ZHOU, Guangdong (CN); Junjie ZHOU, Guangdong (CN)

(72) Inventors: Junxiong ZHOU, Guangdong (CN); Junhao ZHOU, Guangdong (CN); Junjie ZHOU, Guangdong (CN)

(21) Appl. No.: 15/782,869

(22) Filed: Oct. 13, 2017

(30) Foreign Application Priority Data
Aug. 7, 2017 (CN) 201710667837.5

(51) Int. Cl. B65G 47/90; B65H 11/00; B65H 7/02

(52) U.S. Cl. CPC B65G 47/90; B65F 1/1426; B65H 7/02; B65H 11/002

(57) ABSTRACT

Disclosed is a device for assembling a garbage can, comprising a conveying mechanism, a correction device, a film tear-off device, an iron wire detection device, a screw locking device, a plurality of feeding devices, an assembly device, and a feeding and assembly device, wherein the film tear-off device, the correction device, the iron wire detection device, and the screw locking device are sequentially disposed along the conveying mechanism; the plurality of feeding devices, the assembly device, and the feeding and assembly device are alternately disposed between the film tear-off device, the correction device, the iron wire detection device and the screw locking device. The device for assembling a garbage can of the present invention is used for the automatic assembly and production of a garbage can.

### BACKGROUND OF THE INVENTION

The present invention relates to the technical field of garbage can production, in particular to a device for assembling a garbage can.

Garbage can is a necessary article in daily life. The existing garbage can production mode is: an operator operates a single workstation on an auxiliary platform, and then the semi-finished hinge is conveyed to the next workstation via a conveyor belt to complete the next process step until the process steps are all completed.

Such a production mode may have the following problems and defects: intensive semi-automatic or manual labor strength and low yield due to the big size of materials; potential safety hazards such as manual feeding; material inconsistency and shortage when feeding materials by an operator, and high waste product rate; high requirement for the proficiency of a worker, reduced yield and low good finished product rate due to unavoidable human factors.

### BRIEF SUMMARY OF THE INVENTION

The technical problem to be solved by the present invention is providing a device for automatically producing a garbage can.

To achieve the above object, the present invention provides a device for assembling a garbage can, comprising a conveying mechanism, a correction device, a film tear-off device, an iron wire detection device, a screw locking device, a plurality of feeding devices, an assembly device, and a feeding and assembly device, wherein the film tear-off device, the correction device, the iron wire detection device, and the screw locking device are sequentially disposed along the conveying mechanism; the plurality of feeding devices, the assembly device, and the feeding and assembly device are alternately disposed between the film tear-off device, the correction device, the iron wire detection device and the screw locking device; the feeding devices is used for feeding components; the assembly device is used for assembling a plurality of components; and the feeding and assembly device is used for feeding and assembling components.

Further, each feeding device comprises a base feeding manipulator and a pedal feeding and assembly device.

Further, the feeding and assembly device comprises an ornament feeding and assembly device and a connecting piece feeding and assembly device.

Further, the assembly device comprises a can body and base assembly manipulator, a stay wire assembly manipulator, a can cover and S-shaped hook assembly manipulator, an inner label sticking manipulator, an outer label sticking manipulator, an inner can assembly manipulator, and an anti-fingerprint sticker sticking manipulator, wherein the can body and base assembly manipulator, the stay wire assembly manipulator, the can cover and S-shaped hook assembly manipulator, the inner label sticking manipulator, the outer label sticking manipulator, the inner can assembly manipulator, and the anti-fingerprint sticker sticking manipulator are respectively disposed along the conveying mechanism.

Further, the film tear-off device comprises a CCD visual detection device, a tool tip moving manipulator, a tool tip, a material delivery manipulator, and a rotating disc, wherein the CCD visual detection device is used for positioning; the tool tip moving manipulator drives the tool tip to cut a film on an article having a film to be torn off; and the material delivery manipulator picks up and places the article having a film to be torn off on the rotating disc.

Further, the ornament feeding and assembly device comprises an ornament feeding manipulator, a press-fit cylinder, and a vibration disc, wherein the vibration disc is used for feeding an ornament; the ornament feeding manipulator is used for assembling the ornament at a to-be-installed position; and the press-fit cylinder is used for press-fitting the ornament at a to-be-installed position.

Further, the screw locking device comprises a transfer manipulator, a left-right adjustment cylinder, a front-back adjustment cylinder, an upper-lower adjustment cylinder, and a screw feeding mechanism, wherein the transfer manipulator is connected to a screw locking mechanism, and drives the screw locking mechanism to move; the left-right adjustment cylinder, the front-back adjustment cylinder, and the upper-lower adjustment cylinder are used for adjusting the position of a component having a screw to be locked; the screw feeding mechanism is used for feeding a screw; and the screw locking mechanism is used for locking the screw in a screw hole of the component having a screw to be locked.

Further, the conveying mechanism is a double plus chain.

Further, the conveying mechanism is provided thereon with a plurality of jigs matched with the conveying mechanism, wherein the jigs are used for placing a can body and a base.

Further, the device for assembling a garbage is further provided with a can body feeding station for feeding a can body under manual assistance.

The present invention mainly realizes the following beneficial effects: the present invention provides a device for assembling a garbage can, and realizes automatic assembly of a garbage can, thus reducing the workload of manual production, and improving production efficiency; the present invention provides a film tear-off device capable of assisting people to tear off a protective film on the surface of an article, thus reducing the manual film-tearing burden of people; the present invention mainly feeds materials with a manipulator or a vibration disc which has a quick feeding speed and high consistency, thus facilitating the improvement of production efficiency and good product rate; the present invention adopts a CCD visual detection device to detect and correct positions, thus avoiding the generation of bad products due to an inaccurate component position; the present invention adopts an automatic screw locking device to quickly and accurately lock a screw, thus improving the screw locking work efficiency.

### BRIEF DESCRIPTION OF THE DRAWINGS

FIG. 1 is a structural schematic view of the device for assembling a garbage can of the present invention;

FIG. 2 is a structural schematic view of the film tear-off device of the present invention;

FIG. 3 is a structural schematic view of the ornament feeding and assembly device of the present invention; and

FIG. 4 is a structural schematic view of the screw locking device of the present invention.

Explanation on the marks in figures: 1—base feeding manipulator, 2—can body feeding station, 3—film tear-off device, 31—CCD visual detection device, 32—tool tip moving manipulator, 33—tool tip, 34—material delivery manipulator, 35—rotating disc, 4—ornament feeding and assembly device, 41—ornament feeding manipulator, 42—press-fit cylinder, 43—vibration disc, 5—can body and base assembly manipulator, 6—correction device, 7—stay wire assembly manipulator, 8—iron wire detection device, 9—connecting piece feeding and assembly device, 10—screw locking device, 101—transfer manipulator, 102—left-right adjustment cylinder, 103—front-back adjustment cylinder, 104—upper-lower adjustment cylinder, 105—screw feeding mechanism, 106—screw locking mechanism, 11—pedal feeding and assembly device, 12—can cover and S-shaped hook assembly manipulator, 13—inner label sticking manipulator, 14—outer label sticking manipulator, 15—anti-fingerprint sticker sticking manipulator, 16—conveying mechanism, 17—inner can assembly manipulator.

The figures are used for illustrative purpose only, but should not be considered as a limitation of the present patent. To describe the embodiment still better, certain components in the figures may be omitted, enlarged or minified, and do not denote the sizes of a practical product. For a person skilled in the art, omitting certain commonly known structures in the figures and the descriptions thereof is understandable. The same or similar marks correspond to the same or similar components. The words for describing position relationships in the figures are used for illustrative purpose only, but should not be considered as a limitation of the present patent.

### DETAILED DESCRIPTION OF THE INVENTION

To facilitate the understanding of a person skilled in the art, the present invention will be elaborated hereafter in connection with the drawings and an embodiment.

### Embodiment 1

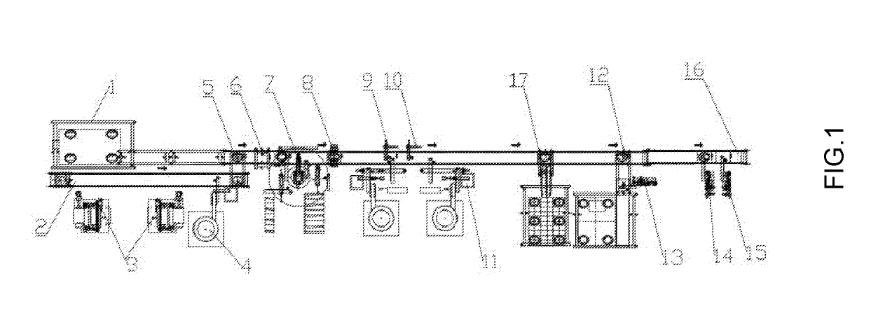

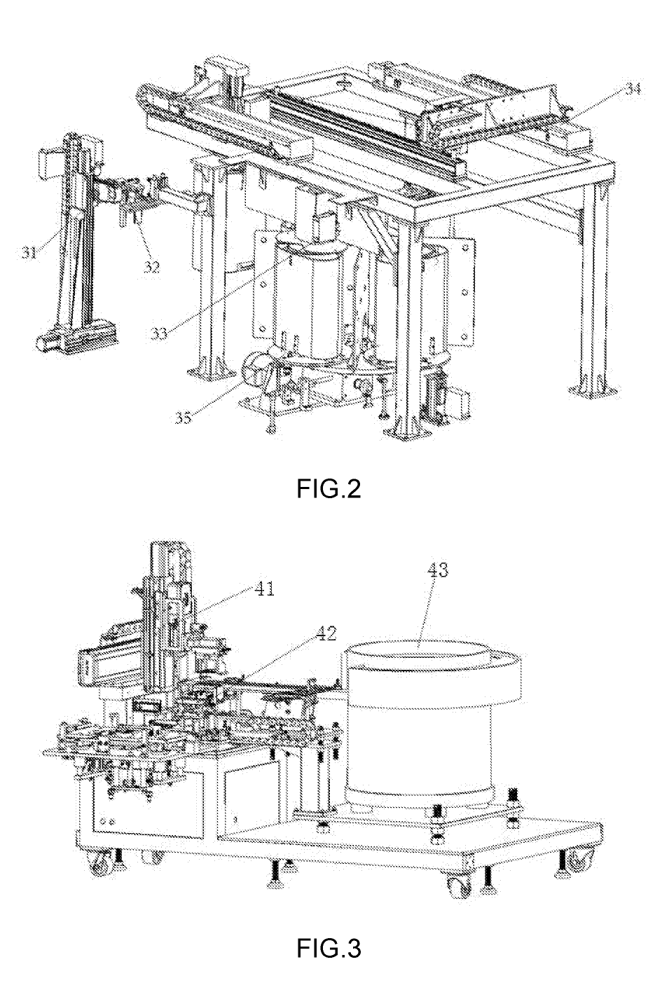

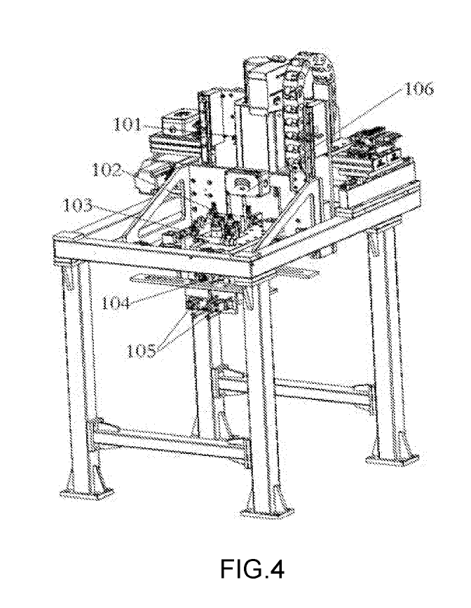

With reference to FIG. 1-4, a device for assembling a garbage can, comprising a base feeding manipulator 1, a film tear-off device 3, an ornament feeding and assembly device 4, a can body and base assembly manipulator 5, a correction device 6, a stay wire assembly manipulator 7, an iron wire detection device 8, a connecting piece feeding and assembly device 9, a screw locking device 10, a pedal feeding and assembly device 11, an inner can assembly manipulator 17, a can cover and S-shaped hook assembly manipulator 12, an inner label sticking manipulator 13, an outer label sticking manipulator 14, an anti-fingerprint sticker sticking manipulator 15, and a conveying mechanism 16. The film tear-off device 3 comprises a CCD visual detection device 31, a tool tip moving manipulator 32, a tool tip 33, a material delivery manipulator 34, and a rotating disc 35; the ornament feeding and assembly device 4 comprises an ornament feeding manipulator 41, a press-fit cylinder 42, and a vibration disc 43; the screw locking device 10 comprises a transfer manipulator 101, a left-right adjustment cylinder 102, a front-back adjustment cylinder 103, an upper-lower adjustment cylinder 104, a screw feeding mechanism 105, and a screw locking mechanism 106; the device for assembling a garbage is further provided with a can body feeding station 2; the conveying mechanism 16 is a double plus chain; the conveying mechanism 16 is provided thereon with a plurality of jigs matched with the conveying mechanism 16, wherein the jigs are used for placing a can body and a base. The ornament feeding and assembly device 4 and the connecting piece feeding and assembly device 9 both comprise a feeding vibration disc and an assembly device.

The CCD visual detection device 31, the tool tip moving manipulator 32, the tool tip 33, the material delivery manipulator 34, the rotating disc 35, and other accessories are assembled into the film tear-off device 3; the ornament feeding manipulator 41, the press-fit cylinder 42, the vibration disc 43, and other accessories are assembled into the ornament feeding and assembly device 4; the transfer manipulator 101, the left-right adjustment cylinder 102, the front-back adjustment cylinder 103, the upper-lower adjustment cylinder 104, the screw feeding mechanism 105, the screw locking mechanism 106, and other accessories are assembled into the screw locking device 10.

The base feeding manipulator 1, the film tear-off device 3, the ornament feeding and assembly device 4, the can body and base assembly manipulator 5, the correction device 6, the stay wire assembly manipulator 7, the iron wire detection device 8, the connecting piece feeding and assembly device 9, the screw locking device 10, the pedal feeding and assembly device 11, the inner can assembly manipulator 17, the can cover and S-shaped hook assembly manipulator 12, the inner label sticking manipulator 13, the outer label sticking manipulator 14, and the anti-fingerprint sticker sticking manipulator 15 are sequentially assembled on the conveying mechanism 16 in the order above.

With reference to FIG. 1-4, the process of utilizing the device for assembling a garbage can of the present invention to assemble a garbage can is as follows:

The base is wholly placed on a dedicated base holder by an operator or a manipulator; the base, together with the base holder, is placed at a position the base feeding manipulator 1 can reach; the base feeding manipulator 1 transfers the base onto the conveying mechanism 16 at a position corresponding to a jig; the can body is placed on the CCD visual detection device 31 by an operator or a manipulator; the CCD visual detection 31 positions the buckling line of the can body; the tool tip moving manipulator 32 drives the tool tip 33 to cut the protective film of the can body back and forth along the buckling line; then the material delivery manipulator 34 transfers the can body to the rotating disc 35; the protective film is manually torn off along the protective film notch cut by the tool tip; after the protective film is torn off, the can body is placed in the jig of the conveying mechanism 16 by an operator or a manipulator; with the rotation of the conveying mechanism 16, the base and the can body, together with the jig, come to an ornament feeding and assembly station at which the ornament feeding and assembly device 4 is located; the vibration disc 43 feeds an ornament to the pickup position of the feeding manipulator 41; the feeding manipulator 41 buckles the ornament at a position corresponding to the can body; the press-fit cylinder 42 extends out and presses the ornament against the can body; then the can body having buckled the ornament and the base, together with the jig, come to a can body and base assembly station at which the can body and base assembly manipulator 5 is located; the can body and base assembly manipulator 5 lifts the can body from the jig and presses the can body into the base.

After the can body is assembled in the base, with the rotation of the conveying mechanism 16, the jig comes to a correction station at which the correction device 6 is located; the CCD visual detection mechanism of the correction device 6 determines whether the buckling line of the can body is at the correct position; if incorrect, then the can body is clamped by a manipulator on the correction device 6, and is rotated to the correct position together with the base; then the jig comes to a stay wire assembly station at which the stay wire assembly manipulator 7 is located; a transverse iron wire and a vertical iron wire are respectively placed in a transverse iron wire clamp and a vertical iron wire clamp; the stay wire assembly manipulator 7 first picks up the transverse iron wire from the transverse iron wire clamp, and assembles the transverse iron wire from the lateral surface of the can body, and then picks up the vertical iron wire from the vertical iron wire clamp, and assembles the vertical iron wire from the upper surface of the can body; then the jig enters a detection station at which the iron wire detection device 8 is located; the iron wire detection device 8 extends the manipulator thereof into the can body where the transverse and vertical iron wires are located to detect whether the transverse and vertical iron wires are installed in place; if no, then the iron wire detection device 8 pokes the transverse iron wire or the vertical iron wire in place via the manipulator thereof.

Then the semi-finished product, together with the jig, enters a connecting piece feeding and assembly station at which the connecting piece feeding and assembly device 9 is located; the vibration disc of the connecting piece feeding and assembly device 9 feeds a connecting piece; the manipulator of the connecting piece feeding and assembly device 9 buckles the connecting piece at a position corresponding to the can body; then the jig enters a screw locking station at which the screw locking device 10 is located; the left-right adjustment cylinder 102, the front-back adjustment cylinder 103, and the upper-lower adjustment cylinder 104 adjust the position of the can body; after the position is adjusted, the screw feeding mechanism 105 conveys the semi-finished product to a screw locking position; the transfer manipulator 101 drives the screw locking mechanism 106 to rotate to lock the screw, such that the connecting piece and the can body are locked together via screws.

Then the semi-finished product, together with the jig, enters a pedal feeding and assembly station at which the pedal feeding and assembly device 11 is located; first the vibration disc feeds a pedal, then the manipulator of the pedal feeding and assembly device 11 buckles the connecting piece at a position corresponding to the can body; the semi-finished product, together with the jig, enters an inner can assembly station at which the inner can assembly manipulator 17 is located; the inner can assembly manipulator 17 picks up an inner can from an inner can placement frame, and places the inner can in the can body; then the semi-finished product, together with the jig, enters a can cover and S-shaped hook assembly station at which the can cover and S-shaped hook assembly manipulator 12 is located; first the inner label sticking manipulator 13 picks up an entire inner label, and sticks the inner label inside the can cover, then the can cover and S-shaped hook assembly manipulator 12 picks up the can cover from a can cover placement frame, and clamps the can cover on the connecting piece, and finally the can cover and S-shaped hook assembly manipulator picks up an S-shaped hook from an S-shaped hook frame, and installs the S-shaped hook between the can cover and the vertical iron wire.

A finished garbage can product is assembled completely to the present step; then the finished product, together with the jig, sequentially enters an outer label sticking station at which the outer label sticking manipulator 14 is located, and an anti-fingerprint sticker sticking station at which the anti-fingerprint sticker sticking manipulator 15 is located; the outer label sticking manipulator 14 and the anti-fingerprint sticker sticking manipulator 15 sequentially sticks an outer label and an anti-fingerprint sticker; and finally the finished product is taken out by an operator or a manipulator, thus the operations for assembling a garbage can are all completed.

The description above gives a garbage can assembly process, and the process of assembling a garbage can on other jigs of the conveying mechanism 16 is the same.

The description above is only an embodiment of the present invention, but should not be considered as a limitation of the protection scope of the present invention due to the specific and detailed description thereof. It should be pointed out that an ordinarily person skilled in the art could make various variations and improvements without departing from the concept of the present invention. And the obvious substitutions are all concluded in the protection scope of the present invention.

What is claimed is:

1. A device for assembling a garbage can, characterized by: comprising a conveying mechanism (16), a correction device (6), a film tear-off device (3), an iron wire detection device (8), a screw locking device (10), a plurality of feeding devices, an assembly device, and a feeding and assembly device, wherein the film tear-off device (3), the correction device (6), the iron wire detection device (8), and the screw locking device (10) are sequentially disposed along the conveying mechanism (16); the plurality of feeding devices, the assembly device, and the feeding and assembly device are alternately disposed between the film tear-off device (3), the correction device (6), the iron wire detection device (8) and the screw locking device (10); the feeding devices is used for feeding components; the assembly device is used for assembling a plurality of components; and the feeding and assembly device is used for feeding and assembling components.

2. The device for assembling a garbage can according to claim 1, characterized in that: each feeding device comprises a base feeding manipulator (1) and a pedal feeding and assembly device (11).

3. The device for assembling a garbage can according to claim 1, characterized in that: the feeding and assembly device comprises an ornament feeding and assembly device (4) and a connecting piece feeding and assembly device (9).

4. The device for assembling a garbage can according to claim 1, characterized in that: the assembly device comprises a can body and base assembly manipulator (5), a stay wire assembly manipulator (7), a can cover and S-shaped hook assembly manipulator (12), an inner label sticking manipulator (13), an outer label sticking manipulator (14), an inner can assembly manipulator (17), and an anti-fingerprint sticker sticking manipulator (15), wherein the can body and base assembly manipulator (5), the stay wire assembly manipulator (7), the can cover and S-shaped hook assembly manipulator (12), the inner label sticking manipulator (13), the outer label sticking manipulator (14), the inner can assembly manipulator (17), and the anti-fingerprint sticker sticking manipulator (15) are respectively disposed along the conveying mechanism (16).

5. The device for assembling a garbage can according to claim 1, characterized in that: the film tear-off device (3) comprises a CCD visual detection device (31), a tool tip moving manipulator (32), a tool tip (33), a material delivery manipulator (34), and a rotating disc (35), wherein the CCD visual detection device (31) is used for positioning; the tool tip moving manipulator (32) drives the tool tip (33) to cut a film on an article having a film to be torn off; and the material delivery manipulator (34) picks up and places the article having a film to be torn off on the rotating disc (35).

6. The device for assembling a garbage can according to claim 3, characterized in that: the ornament feeding and assembly device (4) comprises an ornament feeding manipulator (41), a press-fit cylinder (42), and a vibration disc (43), wherein the vibration disc (43) is used for feeding an ornament; the ornament feeding manipulator (41) is used for assembling the ornament at a to-be-installed position; and the press-fit cylinder (42) is used for press-fitting the ornament at a to-be-installed position.

7. The device for assembling a garbage can according to claim 1, characterized in that: the screw locking device (10) comprises a transfer manipulator (101), a left-right adjustment cylinder (102), a front-back adjustment cylinder (103), an upper-lower adjustment cylinder (104), and a screw feeding mechanism (105), wherein the transfer manipulator (101) is connected to a screw locking mechanism (106), and drives the screw locking mechanism (106) to move; the left-right adjustment cylinder (102), the front-back adjustment cylinder (103), and the upper-lower adjustment cylinder (104) are used for adjusting the position of a component having a screw to be locked; the screw feeding mechanism (105) is used for feeding a screw; and the screw locking mechanism (106) is used for locking the screw in a screw hole of the component having a screw to be locked.

8. The device for assembling a garbage can according to claim 1, characterized in that: the conveying mechanism (16) is a double plus chain.

9. The device for assembling a garbage can according to claim 1, characterized in that: the conveying mechanism (16) is provided thereon with a plurality of jigs matched with the conveying mechanism (16), wherein the jigs are used for placing a can body and a base.

10. The device for assembling a garbage can according to claim 1, characterized in that: the device for assembling a garbage is further provided with a can body feeding station (2) for feeding a can body under manual assistance.
